(19) United States
(12) Patent Application Publication
(10) Pub. No.: US 2011/0174812 A1
(43) Pub. Date: Jul. 21, 2011

(54) Collapsible Garbage Container

(76) Inventor: Shelby Ray Ainsworth, Jackson, MS (US)

(21) Appl. No.: 12/688,067

(22) Filed: Jan. 15, 2010

(51) Int. Cl. B65F 1/14; B65F 1/00

(52) U.S. Cl. 220/9.4

(57) ABSTRACT

A collapsible garbage container is disclosed. In one embodiment, a frame made from tubular members is utilized. The frame's four vertical members are connected by pairs of crossed legs. Each pair of crossed legs are pivotally connected at their approximate centers by a pivot pin. The upper and lower ends of the pairs of crossed legs are connected together and to the four vertical members using connector pads. A flexible bag is mounted on the frame, and may be utilized to receive a disposable garbage bag. The flexible bag is attached to the vertical members of the frame. The collapsible garbage container folds into a compact space and can be inserted into an appropriately sized bag for transport.

### TECHNICAL FIELD OF THE INVENTION

This invention relates, in general, to garbage containers, and, in particular to a collapsible garbage container which utilizes a tubular frame of cris-crossing, foldable members that permit the container to be folded into a small shape and easily transported.

### BACKGROUND OF THE INVENTION

Conventional garbage or trash cans are fabricated from metal or synthetic plastic materials and are designed to withstand rough handling. It is common practice to line garbage cans with plastic trash bags when refuse to be collected in the cans is in the form of substances which tend to stick or smear the inner surface of the garbage can. The trash bag is typically of sufficient strength so that when filled, it may be tied and then removed from the can and discarded.

Conventional metal or plastic garbage cans are not foldable or collapsible and they occupy a substantial amount of space. The portably and collapsibility of conventional garbage cans is not an issue in most settings since they usually remain in one location for the life of the container. Often however, garbage collection is required in the outdoors and locations away from a place where there is a regular garbage collection. Campers, for example, often need to collect the garbage they produce at their campsite in their own garbage containers. In these circumstances, a portable collapsible garbage can is desirable. Campers preferably would like to be able to transport their garbage containers with them to the campsite.

A number of prior art devices have produced a portable can or garbage bag support. Yet, all of the prior art fails to address needs filled by the current invention. Among these are the need for the container that is strong and durable while also readily and easily foldable into a conveniently transportable shape that can be quickly inserted into a carrying case. Accordingly there is a need for sturdy garbage container which can be easily and readily folded from and then back to a conveniently transportable shape that can then be easily inserted into a carrying case for ease of transportation and which overcomes the prior art's shortcomings. This is particularly useful for campers, picnickers, outdoors men and other activities away from locations with permanent garbage cans.

### SUMMARY OF THE INVENTION

A collapsible garbage container is disclosed which provides improvements with respect to strength of the container and the ease with which the container can be folded into a small shape and transported.

### BRIEF DESCRIPTION OF THE DRAWINGS

For a more complete understanding of the features and advantages of the present invention, reference is now made to the detailed description of the invention along with the accompanying figures in which corresponding numerals in different figures refer to corresponding parts and in which:

FIG. 1 is a perspective view of one embodiment of a collapsible garbage container in an unfolded state;

FIG. 2 is a perspective view of one embodiment of a collapsible garbage container in a folded state;

FIG. 3 is an enlarged sectional view of the flexible bag and vertical member connection.

### DETAILED DESCRIPTION OF THE INVENTION

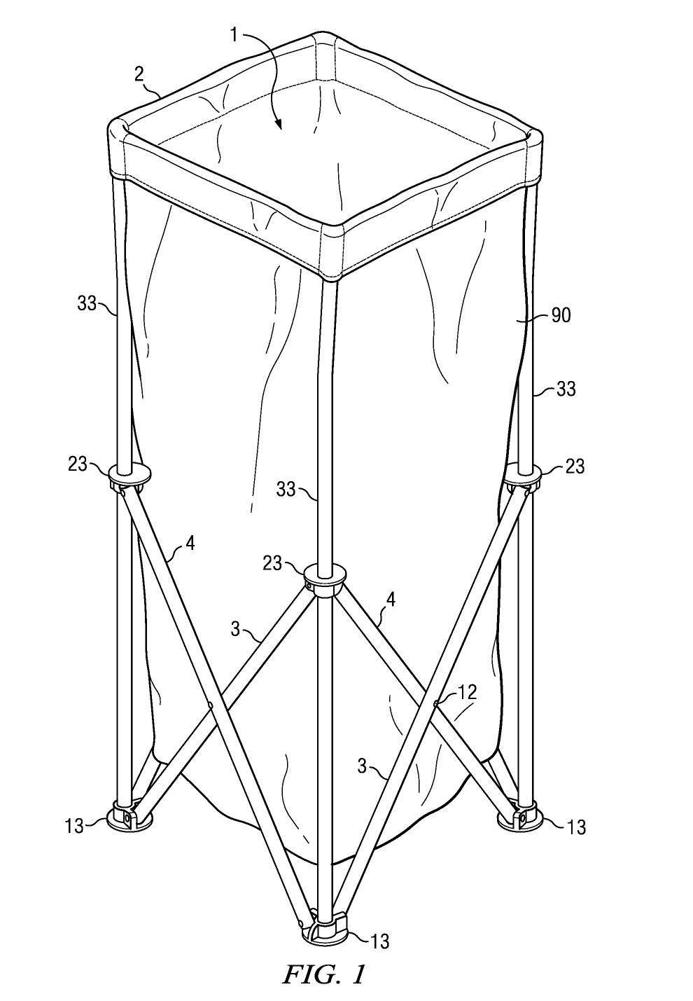

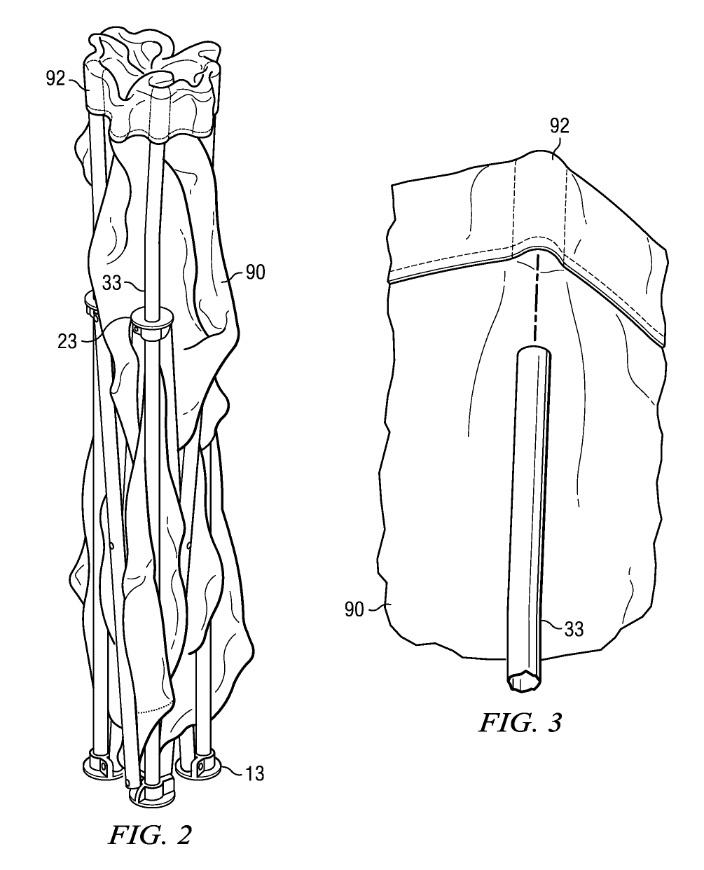

The collapsible garbage container 1 of the present invention, as shown in FIGS. 1-3, has a frame 2 made from tubular members or legs. The frame has four pair of crossed legs 3, 4; and four vertical members 33. Each pair of crossed legs are pivotally connected at their approximate centers by a pivot pin 12. The lower ends of the pairs of crossed legs are connected together using lower connector pads 13. The upper ends of the pairs of crossed legs are connected together using upper connector pads 23.

Eight connector pads are provided, one at each lower corner of the container and one at each upper corner connection point of the pairs of crossed legs. Each lower connector pad 13 is pivotally connected in one plane to the lower end of a crossed leg 4 of one pair of the crossed legs and pivotally connected in a second plane to the lower end of a crossed leg 3 of a second pair of the crossed legs. The lower ends of each pair of crossed legs is thereby connected to the lower connector pads 13. Each upper connector pad 23 is pivotally connected in one plane to the upper end of a crossed leg 4 of one pair of the crossed legs and pivotally connected in a second plane to the upper end of a crossed leg 3 of a second pair of the crossed legs. The upper ends of each pair of crossed legs is thereby connected to the upper connector pads 23.

The four lower connector pads, 13, are identical. As shown in FIG. 1, each pad comprises a bottom surface, a slot, and two extending arms. The slot is sized to snugly receive the lower end of one vertical member 33, and each extending arm proceeds from the slot along the top side of the bottom surface in a plane to be pivotally connected to the lower end of a crossed leg 3 or 4.

The four upper connector pads, 23, are identical. As shown in FIG. 1, each pad comprises a top surface, an aperture, and two extending arms. The aperture is sized to snugly and slideably receive a vertical member 33, and each extending arm proceeds from the aperture along and beneath the top surface in a plane to be pivotally connected to the upper end of a crossed leg 3 or 4.

The extending arms of the lower connector pads, 13, and the upper connector pads 23 are sized to allow a pivotal connection to crossed legs 3 and 4 and to permit the crossed legs to swing, thereby allowing the frame to fold and unfold as the upper connector pads 23 slide along vertical members 33.

The slideable connection between upper pads 23 and vertical members 33 in combination with the pivot pins in each pair of crossed legs permits the frame to be stretched out or unfolded to a square container shape or to be folded up or collapsed into a bundled shape. When the frame is folded up, the vertical members 33 remain parallel to each other and move toward each other while the upper pads 23 slide on the vertical members as the sides, and the front and back of the frame move together.

A flexible bag 90 is be mounted on the frame 2. As seen in FIG. 3, bag 90 has pockets 92 sized to fit over the top of vertical members 33. Bag 90 is thereby supported and held in place by the vertical members 33 attached to bag 90 by pockets 92. The bag 90 can be of semi-permanent material, such as canvas, and sized to receive and support disposable garbage bags.

In all embodiments, the collapsible garbage container folds into a compact space and can be inserted into an appropriately sized bag for transport.

The invention claimed is:

1. A collapsible garbage container comprising:
a frame comprised of four pairs of crossed legs pivotally connected;
and four vertical members;
the lower ends of the crossed legs pivotally connected to lower pads;
the lower pads acting to support the garbage container on a surface;
the upper ends of the crossed legs pivotally connected to upper pads;
the lower pads are substantially similar, each having a bottom surface, a slot, and two extending arms;
the slots sized to receive the vertical members on the bottom surface of the lower pads;
the upper pads are substantially similar, each having a top surface, an aperture, and two extending arms;
the aperture extending through the upper pad, and sized to slideably receive the vertical members;
the vertical members extending from the slot in the lower pads and passing through the aperture in the upper pads;
a flexible bag connected to the frame at the tops of the vertical members.

2. A collapsible garbage container as claimed in claim 1 wherein the flexible bag has pocket means sized to fit over the top of the vertical members.
